(19) United States
(12) Patent Application Publication
(10) Pub. No.: US 2006/0002470 A1
(43) Pub. Date: Jan. 5, 2006

(54) Motion vector detection circuit, image encoding circuit, motion vector detection method and image encoding method

(75) Inventor: Ryoji Sakurai, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 11/171,358

(22) Filed: Jul. 1, 2005

(30) Foreign Application Priority Data
Jul. 1, 2004 (JP) 2004-196140

(51) Int. Cl. H04N 11/04

(52) U.S. Cl. 375/240.12

(57) ABSTRACT

The vector detecting unit detects a motion vector even for a block that is encoded in the intra mode, and the detected motion vector is stored in the reference vector storing unit. Even for a block that has been encoded in the intra mode, the initial vector calculating unit calculates an initial point with the use of a reference vector, the initial point serving as an initial point used in a motion vector detection process during hierarchical block matching. Thus, it is possible to calculate an initial point with a high precision level with the use of motion information from the vicinity of a target block for which a motion vector is to be detected.

This Nonprovisional application claims priority under 35 U.S.C. §119(a) on Patent Application No. 2004-196140 filed in Japan on Jul. 1, 2004, the entire contents of which are hereby incorporated by reference.

### BACKGROUND OF THE INVENTION

1. Field of the Invention

The present invention relates to a motion vector detection circuit for detecting a motion vector using a predetermined method such as a three-step method and a hierarchical search method, an image encoding circuit using the motion vector detection circuit, a motion vector detection method, and an image encoding method using the motion vector detection method.

2. Description of the Related Art

Conventionally, a reference pixel used in the encoding process of a still image is a pixel that has already been encoded in the image. Such an encoding process is referred to as the intra mode (or the intra-frame prediction encoding). On the other hand, in the case of a moving image, a pixel in a previous frame such as an immediately preceding frame or a frame even before that may be used as a reference pixel. Such an encoding process is referred to as the inter mode (or the inter-frame prediction encoding). During this type of encoding process, a difference between a reference image and an encoding target image is obtained. When the inter mode is used, in the case where a difference between frames is simply calculated, the efficiency level of the encoding process is largely degraded if the corresponding points (for example, the positions of a moving object) in a preceding frame image and a following frame image deviate from each other to a large extent.

To cope with this situation, the preceding frame is compared with the following frame so that the motion in the image (a motion vector) is detected, and the motion that occurs between the frames (for example, the positions of a moving object) is compensated by shifting the preceding frame (the reference image) in accordance with the detected motion (the shift amount and the shift direction; a motion vector). With this arrangement, it is possible to reduce the data amount for the differences and to perform the encoding process more efficiently.

In order to perform the encoding process of moving images with high efficiency, detection of motion vectors is the most importance factor. It is well known that depending on the precision level of the motion vector detection process, the efficiency level of the encoding process is largely lowered. In addition, It is very important to reduce the amount of calculation required for the motion vector detection process. Conventionally, many suggestions have been made with regards to how to reduce the amount of calculation while the precision level is also improved.

These suggested methods include a three-step search method and a hierarchical search method. According to these methods, unlike the full search method by which a search is made through the whole search range of motion vectors thoroughly, the position of an initial vector determined in accordance with a predetermined evaluation value is used as a search starting point, and block matching is performed only in a limited range in the vicinity of the position of the initial vector. This way, the amount of calculation is reduced and the precision level for the motion vector detection process is improved.

When these methods are used, it is important how to calculate an initial vector. Generally speaking, an initial vector of a target block is calculated from a motion vector that has already been detected (i.e. a detected motion vector) for a block that is positioned in the vicinity (i.e. a vicinity block) of the target block for which a motion vector is to be detected (i.e. a target block).

FIG. 6 is a block diagram that shows an example of a configuration of a conventional image encoding circuit.

As shown in FIG. 6, the image encoding circuit 60 includes: a motion vector detection circuit 600; a motion compensating unit 606; and an encoding processing unit 607.

The motion vector detection circuit 600 includes: a block dividing unit 601; a predicted vector calculating unit 602; a motion vector detecting unit 603; a motion vector storing unit 604; and a motion vector outputting unit 605.

The block dividing unit 601 divides an image into a plurality of blocks in units of, for example, 16 pixels by 16 pixels, or 8 pixels by 8 pixels.

The predicted vector calculating unit 602 calculates, for example, a median value of the detected motion vectors as a predicted vector for the target block, using the detected motion vectors of the vicinity blocks.

The motion vector detecting unit 603 uses the predicted vector as an initial vector and detects a motion vector with the use of a hierarchical block matching method or a three-step block matching method, using the position of the initial vector as a search starting point.

The motion vector storing unit 604 stores the detected motion vector into a memory.

The motion vector outputting unit 605 outputs a difference between the detected motion vector and the predicted vector, as a differential motion vector.

The motion compensating unit 606 generates a reference image from the detected motion vector and calculates a difference between the reference image and an encoding target image.

The encoding processing unit 607 performs an encoding process such as discrete cosine transform (DCT), quantization, variable length coding (VLC), or the like, on the calculated difference.

As a related subject to this process, for example, Japanese Unexamined Patent Application Publication No. 2000-253407 suggests a method of calculating an initial vector with a high precision level by calculating the initial vector while a variance between detected motion vectors of vicinity blocks is taken into account and thereby detecting a motion vector with a high precision level.

A technique called “intra refresh” is known by which a certain block within a frame is intentionally refreshed to be in the intra mode (or the intra-frame prediction encoding mode) in order to avoid the situation where an error is mixed into encoded data during the process of transferring the encoded data, and the disorder in the image therefore spreads from one frame to another when the encoded data is decrypted. In the case where this intra refresh technique is used along with the motion vector detection process, a problem is that it is not possible to calculate an appropriate initial vector according to conventional techniques.

In such a situation, since the motion vector detection process is not performed for a block that has gone through the intra refresh process, the block is dealt with as the motion vector being a 0 (zero) vector, or is dealt with as having no vector to begin with.

In actuality, however, the block that has gone through the intra refresh process is forcefully put into the intra mode, in order to reduce the risk of having errors spread when the encoded data is decrypted; therefore, since the motion vector information for such a block is not utilized, it is not possible to calculate a more appropriate initial vector.

In view of the problem with the conventional technique as described above, the present invention aims to provide a motion vector detection circuit capable to calculate a more appropriate initial vector and to perform an encoding process with a high efficiency level, oven if there are one or more blocks that have gone through the intra refresh process, an image encoding circuit using the motion vector detection circuit, a motion vector detection method, and an image encoding method using the motion vector detection method.

### SUMMARY OF THE INVENTION

According to one aspect of the invention, a motion vector detection circuit is provided for detecting a motion vector from a moving image, including: a block dividing unit operable to divide an image into a plurality of blocks; an encoding mode determining unit operable to determine which one of an intra mode and an inter mode is used to encode each of the blocks divided by the block dividing unit, based on a predetermined method; a predicted vector calculating unit operable to, in a case where vicinity blocks of a target block for which a predicted vector is to be calculated include at least one block that has been encoded in the intra mode out of blocks encoded in the inter mode and blocks encoded in the intra mode, calculate the predicted vector of the target block, using a piece of data set to be a 0 vector; an initial vector calculating unit operable to, in the case where the vicinity blocks include at least one block that has been encoded in the intra mode out of the blocks encoded in the inter mode and the blocks encoded in the intra mode, calculate an initial vector of the target block, using a detected motion vector of the vicinity blocks which include said at least one block that has been encoded in the intra mode; a motion vector detecting unit operable to detect the motion vector, using a position of the initial vector as a search starting point; a motion vector storing unit operable to store the motion vector into a memory as a normal vector value in a case where the target block is encoded in the inter mode, and as a reference vector value in a case where the target block is encoded in the intra mode: and a motion vector outputting unit operable to output, as a differential motion vector, a difference between the motion vector detected by the motion vector detecting unit and the predicted vector.

In one embodiment of the invention, the block dividing unit divides the image into the plurality of blocks in units of 16 pixels by 16 pixels or 8 pixels by 8 pixels, in a case where the image is encoded according to an MPEG (Moving Picture Experts Group)-4 method.

In one embodiment of the invention, the encoding mode determining unit either randomly determines the encoding mode within each frame or determines the encoding mode as the intra mode for a block in which a motion in a preceding frame is relatively large.

In one embodiment of the invention, the predicted vector calculating unit calculates, as the predicted vector of the target block, a median value of motion vectors of the vicinity blocks.

In one embodiment of the invention, the initial vector calculating unit calculates, as the initial vector of the target block, a median value of motion vectors of the vicinity blocks.

In one embodiment of the invention, the motion vector detecting unit detects the motion vector by performing block matching according to either a three-step search method or a hierarchical search method.

According to another aspect of the invention, an image encoding circuit is provided, including: a motion vector detection circuit described above; a motion compensating unit operable to generate a reference image based on the differential motion vector outputted from the motion vector outputting unit and calculate a difference between the reference image and the image to be encoded; and an encoding processing unit operable to perform an encoding process on the difference calculated by the motion compensating unit.

In one embodiment of the invention, the encoding processing unit performs the encoding process with the use of Discrete Cosine Transform (DCT), quantization, or Variable Length Coding (VLC).

According to another aspect of the invention, a motion vector detection method is provided for detecting a motion vector from a moving image, including the steps of: (a) dividing an image into a plurality of blocks; (b) determining which one of an intra mode and an inter mode is used to encode each of the blocks divided in the step (a), based on a predetermined method; (c) in a case where vicinity blocks of a target block for which a predicted vector is calculated include at least one block that has been encoded in the intra mode out of blocks encoded in the inter mode and blocks encoded in the intra mode, calculating the predicted vector of the target block, using a piece of data set to be a 0 vector; (d) in the case where the vicinity blocks include at least one block that has been encoded in the intra mode out of the blocks encoded in the inter mode and the blocks encoded in the intra mode, calculating an initial vector of the target block, using a detected motion vector of the vicinity blocks which include said at least one block that has been encoded in the intra mode; (e) detecting the motion vector, using a position of the initial vector as a search starting point; (f) storing the motion vector into a memory as a normal vector value in a case where the target block is encoded in the inter mode, and as a reference vector value in a case where the target block is encoded in the intra mode; and (g) outputting, as a differential motion vector, a difference between the motion vector detected in the step (e) and the predicted vector.

According to another aspect of the invention, an image encoding method is provided, including the steps (a) to (g) included in the motion vector detection method described above, the image encoding method further including: (h) generating a reference image based on the differential motion vector outputted in the step (g) and calculating a difference between the reference image and the image to be encoded; and (i) performing an encoding process on the difference calculated in the step (h).

The following describes how the present invention works with the configuration mentioned above.

According to the present invention, when a motion vector is detected in a moving image, an initial vector which serves as a search starting point (i.e. an initial point) is calculated with the use of detected motion vectors for the vicinity blocks that have been encoded in the inter mode and in the intra mode.

Thus, the motion vector information of blocks that have been encoded in the intra mode are also utilized. Accordingly, even if there is one or more blocks that have gone through the intra refresh process, it is possible to calculate a more appropriate initial vector and to perform the motion vector detection process with a high precision level so as to perform the encoding process with a high efficiency level.

According to the present invention, since an initial vector which serves as a search starting point in the motion vector detection process is calculated with the use of detected motion vector information, no matter what encoding mode is used for the vicinity blocks. Accordingly, even if there are one or more blocks that have gone through the intra refresh process, it is possible to set a search starting point for the motion vector detection process with a high precision level. Consequently, it is possible to detect motion vectors with a high precision level, and to perform the encoding process of images with a high efficiency level.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram that shows a configuration example of an image encoding circuit according to an embodiment of the present invention.

FIG. 2 shows an example of calculation of a predicted vector performed by the predicted vector calculating unit shown in FIG. 1, in the case where the encoding process is performed according to the MPEG-4.

FIG. 3 shows an example of calculation of a predicted vector performed by the predicted vector calculating unit shown in FIG. 1, in the case where the vicinity blocks includes one or more blocks that have been encoded in the intra mode.

FIG. 4 shows an example of calculation of an initial vector performed by the initial vector calculating unit in FIG. 1.

FIG. 5 shows an example of motion vector detection process in the cases where an initial vector calculated according to the present invention is used as an initial point and where an initial vector calculated according to a conventional technique is used as an initial point.

FIG. 6 is a block diagram that shows a configuration example of an image encoding circuit according to a conventional technique.

### DESCRIPTION OF THE PREFERRED EMBODIMENTS

The following describes in detail an embodiment of an image encoding circuit according to the present invention, with reference to the drawings.

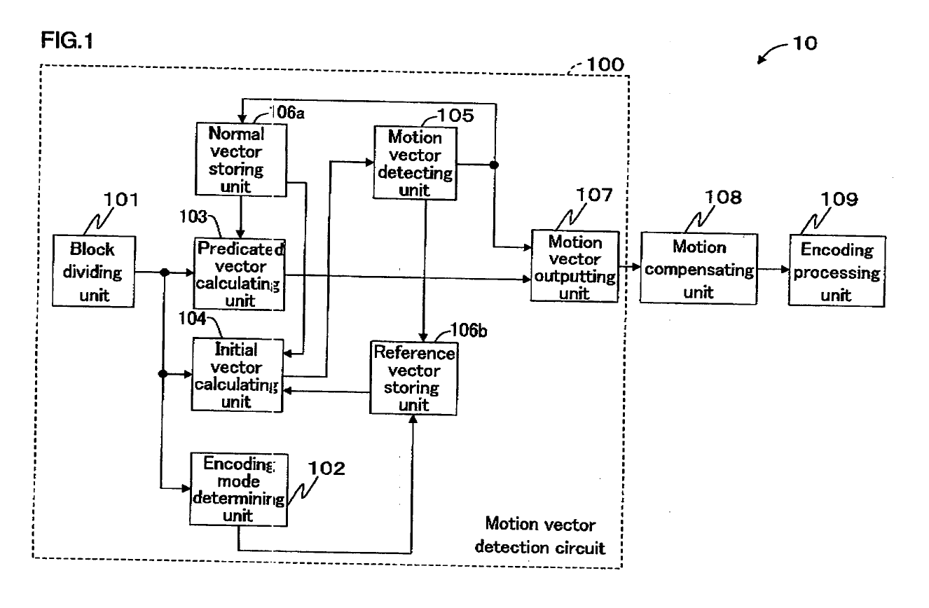

FIG. 1 is a block diagram that shows a configuration example of an image encoding circuit according to an embodiment of the present invention.

As shown in FIG. 1, an image encoding circuit 10 includes: a motion vector detection circuit 100; a motion compensating unit 108; and an encoding processing unit 109.

The motion vector detection circuit 100 includes: a block dividing unit 101; an encoding mode determining unit 102; a predicted vector calculating unit 103; an initial vector calculating unit 104; a motion vector detecting unit 105; a normal vector storing unit 106a and a reference vector storing unit 106b that together serve as a vector storing unit, and a motion vector outputting unit 107.

The block dividing unit 101 divides an inputted image into blocks each having a predetermined size, and assigns an ID number to each of the blocks. The size of the blocks vary depending on the type of the encoding process to be used. For example, when the encoding process is performed according to the MPEG (Moving Picture Experts Group)-4, the inputted image is divided into a plurality of blocks in units of for example, 16 pixels by 16 pixels, or 8 pixels by 8 pixels.

The encoding mode determining unit 102 determines, for each of the blocks obtained by the dividing of the block dividing unit 101, which one of the modes is used for the encoding process, namely, either the intra mode or the inter mode. The method for determining the mode is not limited to any specific methods. The method for determining the mode may be a method for randomly determining the mode within each frame, or it may be a method for determining the mode as the intra mode for a block in which the motion in a preceding frame is relatively large.

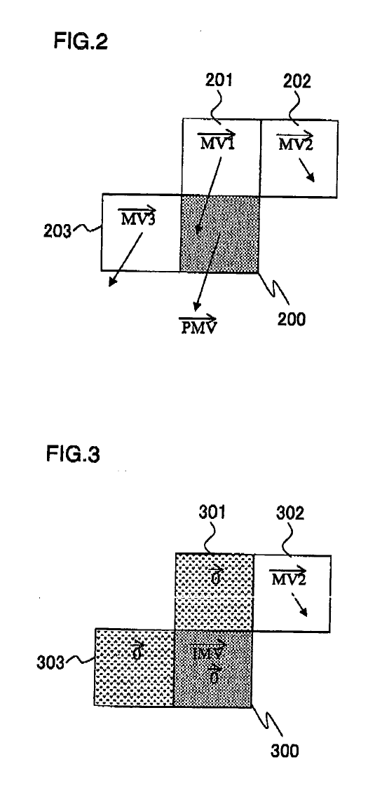

The predicted vector calculating unit 103 calculates a predicted vector for an encoding target block, based on a standard of an image encoding apparatus. Here, the following describes examples of methods for calculating a predicted vector, with reference to FIGS. 2 and 3.

FIG. 2 shows an example of calculation of a predicted vector performed by the predicted vector calculating unit 103 shown in FIG. 1, in the case where the encoding process is performed according to the MPEG-4.

In FIG. 2, in the case where the target block for which a predicted vector is to be calculated (i.e. the target block for which a motion vector is to be detected) is the block 200, using the motion vectors MVs (i.e. the vector MV 1, the vector MV 2, and the vector MV 3) that have already been detected as to the vicinity blocks 201 through 203, median values for X and Y in each the motion vectors are calculated as a vector PMV.
Vector MV 1=(Mv 1x, MV 1y),
Vector MV 2=(MV 2x, MV 2y),
Vector MV 3=(MV 3x, MV 3y),
PMV x=Median (MV 1x, MV 2x, MV 3x)
PMV y=Median (MV 1y, MV 2y, MV 3y)
Vector PMV=(PMV x, PMV y)

FIG. 3 shows an example of calculation of a predicted vector performed by the predicted vector calculating unit 103 shown in FIG. 1, in the case where the vicinity blocks includes one or more blocks that have been encoded in the intra mode.

In FIG. 3, the target block for which a predicted vector is to be calculated is the block 300. The vicinity blocks 301 and 303 are blocks that have been encoded in the intra mode, whereas the vicinity block 302 is a block that has been encoded in the inter mode.

The vicinity block 302 is a block that has been encoded in the inter mode and which has a motion vector being the vector MV 2.

The vicinity blocks 301 and 303 are blocks that have been encoded in the intra mode and each of which has no motion vectors; therefore, the motion vector is recognized to be a “0 vector”.

In such a situation, since median values of the motion vectors of the vicinity blocks 301 through 303 are calculated as a predicted vector PMV for the target block 300, the predicted vector calculating unit 103 outputs a “0 vector” as the predicted vector for the target block 300 as shown below.
Vector MV 1=(0, 0),
Vector MV 2=(MV 2x, MV 2y),
Vector MV 3=(0, 0),
PMV x=Median (0, MV 2x, 0)=0
PMV y=Median (0, MV 2y, 0)=0
Vector PMV=(0, 0)=0(→)

Referring back to FIG. 1, unlike the predicted vector calculating unit 103, the initial vector calculating unit 104 calculates an initial vector which serves as an initial point (a search starting point) used in the motion detection process performed by the motion vector detecting unit 105, based on a detected motion vector, no matter what encoding mode is used for the vicinity blocks.

The motion vector detecting unit 105 detects a motion vector on a presumption that the inter mode is used, even for a block that has been encoded in the intra mode, like the vicinity blocks 301 and 303 that are shown in FIG. 3, for example. The motion vector for a block that has been encoded in the intra mode is stored in the memory as a reference vector by the reference vector storing unit 106b, which servers as part of a vector storing unit.

The predicted vector calculating unit 103 does not treat such a reference vector as a motion vector; however, the initial vector calculating unit 104 treats such a reference vector as a motion vector. In order to calculate an initial vector, the reference vector is inputted from the reference vector storing unit 106b to the initial vector calculating unit 104.

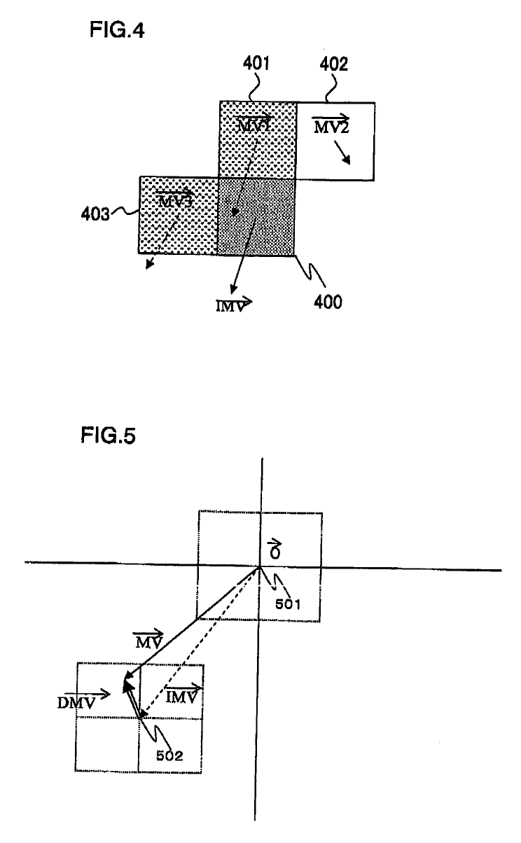

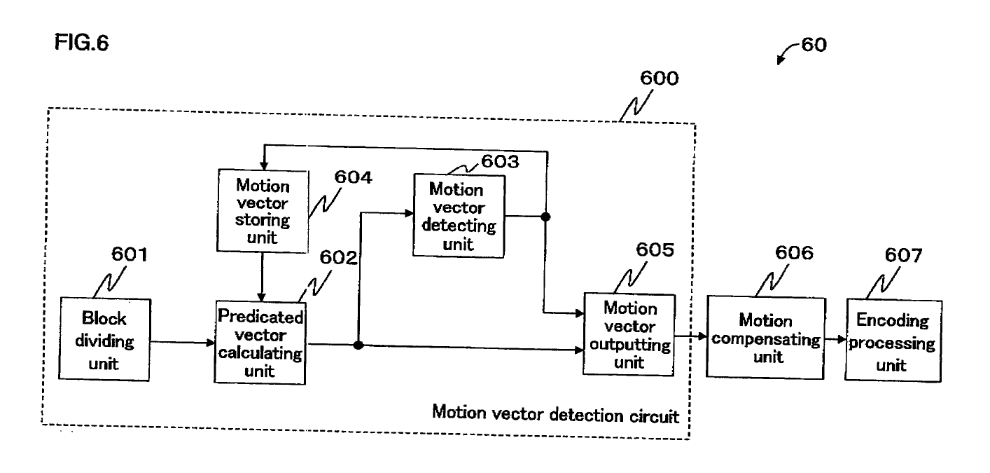

FIG. 4 shows an example of calculation of an initial vector performed by the initial vector calculating unit 104 shown in FIG. 1.

In FIG. 4, the target block for which an initial vector is to be calculated is the block 400. The vicinity blocks 401 and 403 are blocks that have been encoded in the intra mode. The vicinity block 402 is a block that has been encoded in the inter mode.

Since the vicinity blocks 401 and 403 have been encoded in the intra mode, these blocks originally have no motion vectors; however, according to the present embodiment, the motion detection process is performed even for the blocks 401 and 403 that have been encoded in the intra mode so that reference vectors such as the vector MV 1′ and the vector MV 3′ are calculated and stored into the reference vector storing unit 106b.

The vicinity block 302 has been encoded in the inter mode and has a motion vector being the vector MV 2.

As an example of a method of calculating an initial vector IMV for the target block 400 from these vectors, in the case where a method is used in which median values of the motion vectors for the vicinity blocks 401 through 403 are calculated, like in the case of a predicted vector, the results as shown below are obtained:
Vector MV 1′=(MV 1x′, Mv 1y′),
Vector MV 2=(MV 2x, MV 2y),
Vector MV 3′=(MV 3x′, MV 3y′)
INV x=Median (MV 1x′, MV 2x, MV 3x′)
IMV y=Median (MV 1y′, MV 2y, MV 3y′)
Initial Vector IMV=(IMV x, IMV y)

The motion vector detecting unit 105 detects a motion vector for the target block, using the initial vector calculated by the initial vector calculating unit 104 as an initial point (a search starting point).

As for the method of detecting a motion vector, a simple explanation will be provided here while a detailed description will be omitted. For example, a motion vector is detected by performing block matching with the use of a hierarchical search method, a three-step search method, or the like.

Specifically, the three-step search method is to select a number of points (normally 4 points or 8 points) from the vicinity so that some points each having a small prediction error in the block matching process are mainly included, and from among these points, some points each having an even smaller prediction error are searched for. This process is repeated three times until a most appropriate vector is obtained. (In many documents, this method is referred to as TSS, which is for Three-Step Search). On the other hand, the hierarchical search method is to perform a rough vector detection process for a scaled-down screen at first, and then to perform a vector search process in detail for an image before being scaled down in the vicinity of the rough vectors.

As for the vector storing unit, in the case where a target block is encoded in the inter mode, a motion vector is stored into the memory of the normal vector storing unit 106a as a normal vector value, whereas in the case where a target block is encoded in the intra mode, a motion vector is stored into the reference vector storing unit 106b as a reference vector value it should be noted that both normal vectors obtained in the inter mode and reference vectors obtained in the intra mode are stored in the reference vector storing unit 106b. For such a situation, in order to distinguish these vectors, a functional line is provided so as to extend from the encoding mode determining unit 102 to the reference vector storing unit 106b. Accordingly, there is no need to provide a functional line that extends from the normal vector storing unit 106a to the initial vector calculating unit 104.

The motion vector outputting unit 107 calculates a difference between the motion vector MV obtained by the vector detecting unit 105 and the predicted vector PMV calculated by the predicted vector calculating unit 103 and outputs a differential motion vector DMV.

The motion compensating unit 108 generates a reference image from the detected motion vector and the image data for the previous frame and calculates a difference between the reference image and an encoding target image as a piece of difference data.

The encoding processing unit 109 performs an encoding process such as discrete cosine transform (DCT), quantization, variable length coding (VLC), or the like, on the image (the piece of difference data) obtained by the motion compensating unit 108.

According to the conventional techniques, a predicted vector is used as an initial vector which serves as an initial point in the motion vector detection process; therefore, in the case where the vicinity blocks include one or more blocks that are encoded in the intra mode, like the blocks 301 and 303 shown in FIG. 3, the initial vector of the target block 300 is a “0 vector”. For this reason, for example, block matching In which the origin 501 shown in FIG. 5 is used as the center is performed.

It is easily conjectured, however, that there is a high possibility that the target block may also have some motion, based on the motion vector information of the vicinity blocks.

With regard to this situation, in the present embodiment, the initial vector IMV of the target block 400 is calculated using also the detected motion vectors of the vicinity blocks 401 and 403 which have been encoded in the intra mode, as shown in FIG. 4. Due to this arrangement, the initial point 502 which is obtained using the motion information (motion vectors) of the vicinity blocks is more adaptable to the actuality, and block matching is performed while the initial point 502 is used as a search starting point.

The differential motion vector DMV may be larger than one obtained according to conventional techniques; however, since the precision level of the motion vector IMV is higher, it is possible to reduce the amount of difference data for the image outputted by the motion vector outputting unit 107. Thus, it is possible to improve the overall compression efficiency.

As explained so far, according to the present embodiment, the motion vector detecting unit 105 detects a motion vector even for a block that is encoded in the intra mode, and the detected motion vector is stored in the reference vector storing unit 106b. The initial vector calculating unit 104 calculates an initial point, using a reference vector, even for a block that has been encoded in the intra mode, the initial point serving as an initial point used in the motion vector detection process during a hierarchical block matching. With this arrangement, it is possible to calculate an initial point with a high precision level, with the use of motion information from the vicinity of the target block for which a motion vector is to be detected. Accordingly, in the motion detection step during a moving image encoding process, even if the vicinity blocks of a target block for which a motion vector is to be detected include one or more blocks that are encoded in the intra mode, it is possible to detect a motion vector with a high precision level.

As explained so far, although the present invention has been illustrated using the preferred embodiment of the present invention, the present invention should not be construed within the limitation of the embodiment. It is understood that the scope of the present invention should be construed only by the scope claimed in the claims. It is understood that an ordinary person skilled in the art is able to embody an equivalent scope based on the description of the present invention and technical common sense according to the specific preferred embodiment of the present invention. It is understood that the contents of the patents, patent applications, and other documents cited in the present specification should be incorporated by reference for the present specification as if all such publications were incorporated herein.

In the field of a motion vector detection circuit, an image encoding circuit in which such a motion vector detection circuit is used, a motion vector detection method, and an image encoding method in which such a motion vector detection method is used, each of which is for detecting motion vectors with the use of, for example, a three-step method, a hierarchical search method, or the like, the present invention makes it possible to set a search starting point to be used in the motion vector detection process with a high precision level, by calculating an initial vector which serves as a search starting point in the motion vector detection process from detection motion vector information, no matter what encoding mode is used for the vicinity blocks. With this arrangement, when motion vectors are detected with the use of, for example, the three-step method, the hierarchical search method, or the like, it is possible to detect the motion vectors with a high precision level, and to perform an encoding process of images with high efficiency.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A motion vector detection circuit for detecting a motion vector from a moving image, comprising:
a block dividing unit operable to divide an image into a plurality of blocks;
an encoding mode determining unit operable to determine which one of an intra mode and an inter mode is used to encode each of the blocks divided by the block dividing unit, based on a predetermined method;
a predicted vector calculating unit operable to, in a case where vicinity blocks of a target block for which a predicted vector is to be calculated include at least one block that has been encoded in the intra mode out of blocks encoded in the inter mode and blocks encoded in the intra mode, calculate the predicted vector of the target block, using a piece of data set to be a 0 vector;
an initial vector calculating unit operable to, in the case where the vicinity blocks include at least one block that has been encoded in the intra mode out of the blocks encoded in the inter mode and the blocks encoded in the intra mode, calculate an initial vector of the target block, using a detected motion vector of the vicinity blocks which include said at least one block that has been encoded in the intra mode;
a motion vector detecting unit operable to detect the motion vector, using a position of the initial vector as a search starting point;
a motion vector storing unit operable to store the motion vector into a memory as a normal vector value in a case where the target block is encoded in the inter mode, and as a reference vector value in a case where the target block is encoded in the intra mode; and
a motion vector outputting unit operable to output, as a differential motion vector, a difference between the motion vector detected by the motion vector detecting unit and the predicted vector.

2. A motion vector detection circuit according to claim 1, wherein the block dividing unit divides the image into the plurality of blocks in units of 16 pixels by 16 pixels or 8 pixels by 8 pixels, in a case where the image is encoded according to an MPEG (Moving Picture Experts Group)-4 method.

3. A motion vector detection circuit according to claim 1, wherein the encoding mods determining unit either randomly determines the encoding mode within each frame or determines the encoding mode as the intra mode for a block in which a motion in a preceding frame is relatively large.

4. A motion vector detection circuit according to claim 1, wherein the predicted vector calculating unit calculates, as the predicted vector of the target block, a median value of motion vectors of the vicinity blocks.

5. A motion vector detection circuit according to claim 1, wherein the initial vector calculating unit calculates, as the initial vector of the target block, a median value of motion vectors of the vicinity blocks.

6. A motion vector detection circuit according to claim 1, wherein the motion vector detecting unit detects the motion vector by performing block matching according to either a three-step search method or a hierarchical search method.

7. An image encoding circuit comprising:
a motion vector detection circuit according to claim 1;
a motion compensating unit operable to generate a reference image based on the differential motion vector outputted from the motion vector outputting unit and calculate a difference between the reference image and the image to be encoded; and
an encoding processing unit operable to perform an encoding process on the difference calculated by the motion compensating unit.

8. An image encoding circuit according to claim 7, wherein the encoding processing unit performs the encoding process with the use of Discrete Cosine Transform (DCT), quantization, or Variable Length Coding (VLC).

9. A motion vector detection method for detecting a motion vector from a moving image, comprising the steps of:
(a) dividing an image into a plurality of blocks;
(b) determining which one of an intra mode and an inter mode is used to encode each of the blocks divided in the step (a), based on a predetermined method;
(c) in a case where vicinity blocks of a target block for which a predicted vector is calculated include at least one block that has been encoded in the intra mode out of blocks encoded in the inter mode and blocks encoded in the intra mode, calculating the predicted vector of the target block, using a piece of data set to be a 0 vector:
(d) In the case where the vicinity blocks include at least one block that has been encoded in the intra mode out of the blocks encoded in the inter mode and the blocks encoded in the intra mode, calculating an initial vector of the target block, using a detected motion vector of the vicinity blocks which include said at least one block that has been encoded in the intra mode;
(e) detecting the motion vector, using a position of the initial vector as a search starting point;
(f) storing the motion vector into a memory as a normal vector value in a case where the target block is encoded in the inter mode, and as a reference vector value in a case where the target block is encoded in the intra mode; and
(g) outputting, as a differential motion vector, a difference between the motion vector detected in the step (e) and the predicted vector.

10. An image encoding method comprising the steps (a) to (g) included in the motion vector detection method according to claim 9, the image encoding method further comprising:
(h) generating a reference image based on the differential motion vector outputted in the step (g) and calculating a difference between the reference image and the image to be encoded; and
(i) performing an encoding process on the difference calculated in the step (h).
